(19) United States
(12) Patent Application Publication
(10) Pub. No.: US 2017/0371479 A1
(43) Pub. Date: Dec. 28, 2017

(54) Method for Processing Operation and Terminal

(71) Applicant: Huawei Technologies Co., Ltd., Shenzhen (CN)

(72) Inventors: Xiaojuan Li, Beijing (CN); Wenmei Gao, Beijing (CN)

(21) Appl. No.: 15/532,852

(22) PCT Filed: Dec. 3, 2014
(86) PCT No.: PCT/CN2014/092876

§ 371 Date: Jun. 2, 2017

(51) Int. Cl. G06F 3/041; G06F 3/01; G06F 3/044

(52) U.S. Cl. CPC G06F 3/0416; G06F 3/0412; G06F 3/016; G06F 3/044

(57) ABSTRACT

A method includes detecting an operation on a touchscreen, executing a response to the operation when duration of the operation exceeds first preset duration, and returning to a state that exists when the response to the operation is not executed when the duration of the operation exceeds second preset duration, where the second preset duration is greater than the first preset duration. Hence, the technical solutions effectively identify an operation on a touchscreen, and lower a probability of occurrence of a misoperation.

### CROSS-REFERENCE TO RELATED APPLICATION

This application is a U.S. National Stage of International Patent Application No. PCT/CN2014/092876 filed Dec. 3, 2014, which is incorporated by reference herein in its entirety.

### TECHNICAL FIELD

The present disclosure relates to the field of communications technologies, and in particular, to a method for processing an operation and a terminal.

### BACKGROUND

In recent years in order to meet users' requirements for better usage experience and better visual effects, when designing mobile terminals, all manufacturers strive for mobile terminals having increasingly narrow frames such that touchscreens of mobile terminals are increasingly large. In a process of using a mobile terminal, a user accidentally touches a touchscreen very easily, thereby triggering the mobile terminal to execute a response that the user does not want to execute. For example, when a user holds a mobile terminal with one hand, to better balance the mobile terminal, a finger of the user may touch & hold a touchscreen. After detecting that the finger of the user touches & holds the touchscreen, the mobile terminal responds to the touch & hold. However, the user does not want the mobile terminal to respond to the touch & hold. It can be learned that, how to effectively identify an operation on a touchscreen is a technical problem that urgently needs to be resolved.

### SUMMARY

Embodiments of the present disclosure provide a method for processing an operation and a terminal in order to effectively identify an operation on a touchscreen.

A first aspect provides a method for processing an operation, including detecting an operation on a touchscreen, executing a response to the operation when duration of the operation exceeds first preset duration, and returning to a state that exists when the response to the operation is not executed, when the duration of the operation exceeds second preset duration, where the second preset duration is greater than the first preset duration.

With reference to the first aspect, in a first possible implementation manner of the first aspect, executing a response to the operation when duration of the operation exceeds first preset duration includes outputting a short-cut menu corresponding to the operation to the touchscreen when the duration of the operation exceeds the first preset duration, where the short-cut menu includes at least one operation option, and returning to a state that exists when the response to the operation is not executed, when the duration of the operation exceeds second preset duration includes hiding the short-cut menu corresponding to the operation when the duration of the operation exceeds the second preset duration.

With reference to the first aspect or the first possible implementation manner of the first aspect, in a second possible implementation manner of the first aspect, the method further includes detecting another operation on the touchscreen before the operation ends, where a type of the other operation is the same as a type of the operation, and executing a response to the other operation if duration of the other operation exceeds the first preset duration and does not exceed the second preset duration.

With reference to the second possible implementation manner of the first aspect, in a third possible implementation manner of the first aspect, the method further includes returning to a state that exists when the response to the other operation is not executed if the duration of the other operation exceeds the second preset duration.

With reference to the first aspect or the first possible implementation manner of the first aspect, in a fourth possible implementation manner of the first aspect of the embodiments of the present disclosure, before the operation ends, the method further includes detecting another operation on the touchscreen, and executing a response to the other operation, where a type of the other operation is different from a type of the operation.

A second aspect provides another method for processing an operation, including detecting an operation on a touchscreen, where the touchscreen includes a first area and a second area, and the first area surrounds the second area, obtaining a touch area of the operation, determining whether the touch area of the operation is overlapped with both the first area and the second area, and skipping executing a response to the operation if the touch area of the operation is overlapped with both the first area and the second area.

With reference to the second aspect, in a first possible implementation manner of the second aspect, skipping executing a response to the operation includes skipping the response to the operation, or ignoring the response to the operation.

With reference to the second aspect or the first possible implementation manner of the second aspect, in a second possible implementation manner of the second aspect, the method further includes executing the response to the operation if the touch area of the operation is not overlapped with both the first area and the second area.

With reference to any one of the second aspect and the first and the second possible implementation manners of the second aspect, in a third possible implementation manner of the second aspect, the method further includes detecting another operation on the touchscreen before the operation ends, obtaining a touch area of the other operation, determining whether the touch area of the other operation is overlapped with both the first area and the second area, and if the touch area of the other operation is not overlapped with the first area, or the touch area of the other operation is not overlapped with the second area, executing a response to the other operation.

With reference to the third possible implementation manner of the second aspect, in a fourth possible implementation manner of the second aspect, the method further includes skipping executing the response to the other operation if the touch area of the other operation is overlapped with both the first area and the second area.

A third aspect provides a mobile terminal, including a detection module configured to detect an operation on a touchscreen, and a processing module configured to execute a response to the operation when duration of the operation exceeds first preset duration, and return to a state that exists when the response to the operation is not executed when the duration of the operation exceeds second preset duration, where the second preset duration is greater than the first preset duration.

With reference to the third aspect, in a first possible implementation manner of the third aspect, the processing module is further configured to output a short-cut menu corresponding to the operation to the touchscreen when the duration of the operation exceeds the first preset duration, where the short-cut menu includes at least one operation option, and hide the short-cut menu corresponding to the operation when the duration of the operation exceeds the second preset duration.

With reference to the third aspect or the first possible implementation manner of the third aspect, in a second possible implementation manner of the third aspect, the detection module is further configured to detect another operation on the touchscreen before the operation ends, where a type of the other operation is the same as a type of the operation, and the processing module is further configured to execute a response to the other operation if duration of the other operation exceeds the first preset duration and does not exceed the second preset duration.

With reference to the second possible implementation manner of the third aspect, in a third possible implementation manner of the third aspect, the processing module is further configured to return to a state that exists when the response to the other operation is not executed if the duration of the other operation exceeds the second preset duration.

With reference to the third aspect or the first possible implementation manner of the third aspect, in a fourth possible implementation manner of the third aspect, the detection module is further configured to detect another operation on the touchscreen before the operation ends, where a type of the other operation is different from a type of the operation, and the processing module is further configured to execute a response to the other operation.

A fourth aspect provides another mobile terminal, where a touchscreen of the mobile terminal includes a first area and a second area, the first area surrounds the second area, and the mobile terminal includes a detection module configured to detect an operation on a touchscreen, an obtaining module configured to obtain a touch area of the operation, a determining module configured to determine whether the touch area of the operation is overlapped with both the first area and the second area, and a processing module configured to skip executing a response to the operation when the determining module determines that the touch area of the operation is overlapped with both the first area and the second area.

With reference to the fourth aspect, in a first possible implementation manner of the fourth aspect, when the determining module determines that the touch area of the operation is overlapped with both the first area and the second area, the processing module is further configured to skip the response to the operation, or ignore the response to the operation.

With reference to the fourth aspect or the first possible implementation manner of the fourth aspect, in a second possible implementation manner of the fourth aspect, the processing module is further configured to execute the response to the operation when the determining module determines that the touch area of the operation is not overlapped with both the first area and the second area.

With reference to the fourth aspect, the first possible implementation manner of the fourth aspect, and the first possible implementation manner of the fourth aspect, in a third possible implementation manner of the fourth aspect, the detection module is further configured to detect another operation on the touchscreen before the first operation ends. The obtaining module is further configured to obtain a touch area of the other operation. The determining module is further configured to determine whether the touch area of the other operation is overlapped with both the first area and the second area, and when the determining module determines that the touch area of the other operation is not overlapped with the first area, or the touch area of the other operation is not overlapped with the second area, the processing module is further configured to perform a response operation to the other operation.

With reference to the third possible implementation manner of the fourth aspect, in a fourth possible implementation manner of the fourth aspect, the processing module is further configured to skip executing the response to the other operation when the determining module determines that the touch area of the other operation is overlapped with both the first area and the second area.

A fifth aspect provides a mobile terminal, including a bus, a processor and a memory that are connected to the bus, and a touchscreen, where the memory stores program code, and the processor is configured to invoke the program code stored in the memory in order to perform the operations of detecting an operation on a touchscreen, executing a response to the operation when duration of the operation exceeds first preset duration, and returning to a state that exists when the response to the operation is not executed, when the duration of the operation exceeds second preset duration, where the second preset duration is greater than the first preset duration.

With reference to the fifth aspect, in a first possible implementation manner of the fifth aspect, executing, by the processor, a response to the operation includes outputting, by the processor, a short-cut menu corresponding to the operation to the touchscreen, where the short-cut menu includes at least one operation option, and returning, by the processor, to a state that exists when the response to the operation is not executed includes hiding, by the processor, the short-cut menu corresponding to the operation.

With reference to the fifth aspect or the first possible implementation manner of the fifth aspect, in a second possible implementation manner of the fifth aspect, the processor further performs the following operations detecting another operation on the touchscreen before the operation ends, where a type of the other operation is the same as a type of the operation, and executing a response to the other operation if duration of the other operation exceeds the first preset duration and does not exceed the second preset duration.

With reference to the second possible implementation manner of the fifth aspect, in a third possible implementation manner of the fifth aspect, the processor further performs the operation of returning to a state that exists when the response to the other operation is not executed if the duration of the other operation exceeds the second preset duration.

With reference to the fifth aspect or the first possible implementation manner of the fifth aspect, in a fourth possible implementation manner of the fifth aspect, before the operation ends, the processor further performs the operation of detecting another operation on the touchscreen, and executing a response to the other operation, where a type of the other operation is different from a type of the operation.

A sixth aspect provides another mobile terminal, including a bus, a processor and a memory that are connected to the bus, and a touchscreen, where the touchscreen includes a first area and a second area, and the first area surrounds the second area. The memory stores program code, and the processor is configured to invoke the program code stored in the memory, to perform the operations of detecting an operation on a touchscreen, obtaining a touch area of the operation, determining whether the touch area of the operation is overlapped with both the first area and the second area, and skipping executing a response to the operation if the touch area of the operation is overlapped with both the first area and the second area.

With reference to the sixth aspect, in a first possible implementation manner of the sixth aspect, skipping, by the processor, executing a response to the operation includes skipping, by the processor, the response to the operation, or ignoring, by the processor, the response to the operation.

With reference to the sixth aspect or the first possible implementation manner of the sixth aspect, in a second possible implementation manner of the sixth aspect, the processor further performs the operation of executing the response to the operation if the touch area of the operation is not overlapped with both the first area and the second area.

With reference to any one of the sixth aspect and the first and the second possible implementation manners of the sixth aspect, in a third possible implementation manner of the sixth aspect, after the touch area of the operation is overlapped with both the first area and the second area, and before the operation ends, the processor further performs the operations of detecting another operation on the touchscreen, obtaining a touch area of the other operation, determining whether the touch area of the other operation is overlapped with both the first area and the second area, and executing a response to the other operation if the touch area of the other operation is not overlapped with the first area, or the touch area of the other operation is not overlapped with the second area.

With reference to the third possible implementation manner of the sixth aspect, in a fourth possible implementation manner of the sixth aspect, the processor further performs the operation of skipping executing the response to the other operation if the touch area of the other operation is overlapped with both the first area and the second area.

In the embodiments of the present disclosure, when detecting an operation on a touchscreen, a mobile terminal may determine the operation as a valid operation or an invalid operation according to duration of the operation or a touch area of the operation, thereby effectively identifying an operation on the touchscreen and lowering a probability of occurrence of a misoperation.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1A is a schematic flowchart of a method for processing an operation according to an embodiment of the present disclosure;

FIG. 1B is a schematic diagram of holding, by a user, a mobile terminal with one hand;

FIG. 2A is a schematic flowchart of another method for processing an operation according to an embodiment of the present disclosure;

FIG. 2B is a schematic diagram of operating, by a user, a mobile terminal with two hands;

FIG. 3 is a schematic flowchart of another method for processing an operation according to an embodiment of the present disclosure;

FIG. 4A is a schematic flowchart of a method for processing an operation according to an embodiment of the present disclosure;

FIG. 4B is a schematic diagram of a touchscreen according to an embodiment of the present disclosure;

FIG. 5 is a schematic flowchart of another method for processing an operation according to an embodiment of the present disclosure;

FIG. 6 is a schematic flowchart of another method for processing an operation according to an embodiment of the present disclosure;

FIG. 7 is a schematic structural diagram of a mobile terminal according to an embodiment of the present disclosure;

FIG. 8 is a schematic structural diagram of another mobile terminal according to an embodiment of the present disclosure;

FIG. 9 is a schematic structural diagram of a mobile terminal according to an embodiment of the present disclosure; and

FIG. 10 is a schematic structural diagram of another mobile terminal according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are merely a part rather than all of the embodiments of the present disclosure. All other embodiments obtained by a person of ordinary skill in the art based on the embodiments of the present disclosure without creative efforts shall fall within the protection scope of the present disclosure.

Embodiments of the present disclosure provide a method for processing an operation and a terminal, which can lower a probability of occurrence of a misoperation. Detailed descriptions are separately provided below.

It should be noted that, the mobile terminal involved in this specification includes, but is not limited to a mobile phone, a mobile computer, a tablet computer, a personal digital assistant (PDA), a mobile Internet device (MID), a smart watch, smart glasses, a smart band, and the like having a touchscreen.

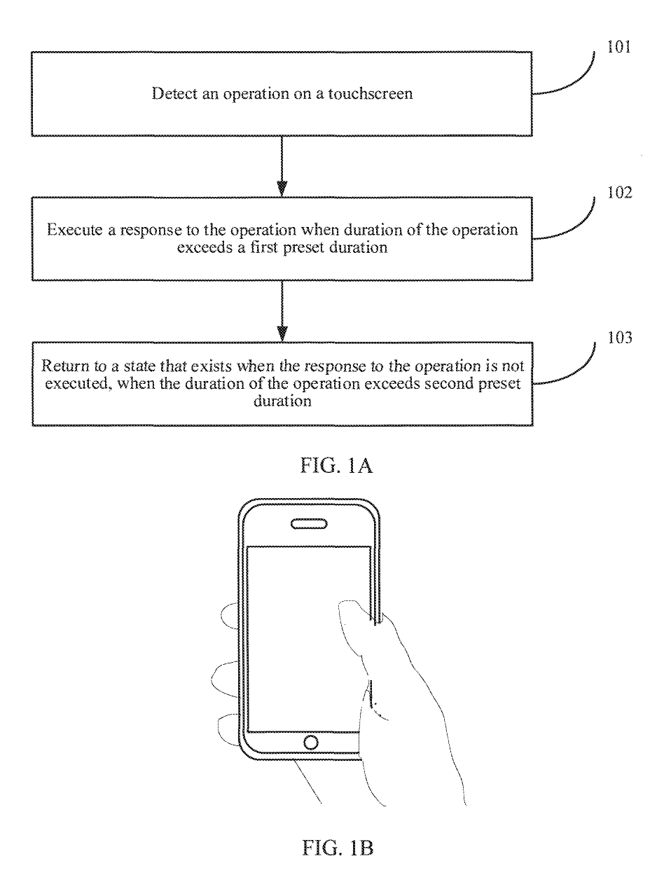

Referring to FIG. 1A, FIG. 1A is a schematic flowchart of a method for processing an operation according to an embodiment of the present disclosure. As shown in FIG. 1A, the method may include the following steps.

It should be noted that, step 101 to step 103 are performed by a mobile terminal or a processor in a mobile terminal, for example, a Central Processing Unit (CPU).

Step 101: Detect an operation on a touchscreen.

In this embodiment of the present disclosure, the touchscreen may also be referred to as a touch panel, a touch sensor, a capacitive touchscreen, or the like. This is not described again below in this embodiment of the present disclosure.

In this embodiment of the present disclosure, a user may input an operation to a mobile terminal using a touchscreen. The operation may include, but is not limited to tap (for example, single tap and double tap), slide, touch & hold, and the like.

The operation is generally touch & hold, which is not described again below in this embodiment of the present disclosure.

It should be noted that, in this embodiment of the present disclosure, the mentioned touchscreen is a touchscreen in a screen-on state unless otherwise described, which is not described again below in this embodiment of the present disclosure.

Step 102: Execute a response to the operation when duration of the operation exceeds first preset duration.

In this embodiment of the present disclosure, duration (first preset duration) may be preset. The first preset duration may be considered as shortest response duration of each function (including a function of the mobile terminal and a function that particular software has) of the mobile terminal, that is, the mobile terminal responds to the operation only when the duration of the operation on the touchscreen reaches a minimum of the first preset duration. For example, the first preset duration (for example, one second) may be set according to parameters such as sensitivity of the touchscreen and response time of each function of the mobile terminal.

Correspondingly, when detecting the operation on the touchscreen, the mobile terminal may collect statistics on duration of the operation. When the duration of the operation exceeds the first preset duration, the mobile terminal needs to respond to the operation, and further, the mobile terminal may execute the response to the operation, for example, a short-cut menu corresponding to the operation pops up, and an object of the operation is set to be in a movable state.

For example, in this embodiment of the present disclosure, when the mobile terminal detects the operation on the touchscreen, and the duration of the operation exceeds the first preset duration, the mobile terminal may output the short-cut menu corresponding to the operation to the touchscreen, where the short-cut menu may include at least one operation option.

For example, the operation is performed when a thumb of the user touches the touchscreen while the user holds the mobile terminal. Assuming that the response, preconfigured in the mobile phone, to the operation is a select operation, and the user may further select an operation such as copy, cut, and delete for an selected object, in this embodiment of the present disclosure, when the mobile terminal detects the foregoing operation, a short-cut menu including operation options such as “copy,” “cut,” and “delete” may pop up on the touchscreen.

Step 103: Return to a state that exists when the response to the operation is not executed, when the duration of the operation exceeds second preset duration.

In this embodiment of the present disclosure, another duration (second preset duration) may be further preset. The second preset duration may be considered as longest response duration of each function (including a function of the mobile terminal and a function that particular software has) of the mobile terminal, that is, when the duration of the operation on the touchscreen exceeds the second preset duration, the mobile terminal may consider that the operation is an invalid operation. If the operation has been responded to, the response to the operation needs to be canceled. The second preset duration is greater than the first preset duration.

Correspondingly, in this embodiment of the present disclosure, after the duration of the operation on the touchscreen exceeds the first preset duration, and the mobile terminal executes the response to the operation, the mobile terminal may continue to collect statistics on the duration of the operation, to determine whether the duration exceeds the second preset duration. If the duration exceeds the second preset duration, the mobile terminal considers that the operation is an invalid operation. The mobile terminal may return to a state that exists when the response to the operation is not executed, for example, hide a pop-up operation box corresponding to the operation, and recover, from a movable state to a normal state, an object corresponding to the operation.

For example, it is assumed that the first preset duration is one second and the second preset duration is three seconds. When the mobile terminal detects an operation on the touchscreen, and duration of the operation exceeds one second, the mobile terminal may execute a response to the operation, for example, set an object (for example, an icon or a picture of an application program) corresponding to the operation to be in a movable state, that is, the user may change a location of the icon or picture of the application program in the state. After the mobile terminal performs the foregoing operation, if the operation does not end yet, the mobile terminal may continue to collect statistics on the duration of the operation. If the duration of the operation exceeds three seconds, the mobile terminal may consider that the operation is an invalid operation. For example, the operation may be an operation of accidental touch of the user. Therefore, the mobile terminal may recover, from a movable state to a normal state, an object corresponding to the operation.

In this embodiment of the present disclosure, when the duration of the operation exceeds the first preset duration, but does not exceed the second preset duration, the mobile terminal may determine that the operation is a valid operation, and normally execute a response to the operation, or the mobile terminal may further determine, using another strategy, whether to cancel the response to the operation. Specific implementation thereof is not limited in this embodiment of the present disclosure.

For example, referring to FIG. 1B, for a mobile terminal having a relatively large screen (for example, a mobile phone having a touchscreen), when using a mobile terminal, a user generally needs to hold the mobile terminal with one hand, and perform an operation (for example, tap and slide) on the mobile terminal with the other hand. When the user holds the mobile terminal with one hand in order to better balance the mobile terminal, a finger of the user easily touches the touchscreen (for example, in FIG. 1B, the user holds the mobile terminal with one hand), thereby triggering the mobile terminal to execute a response that the user does not intend to execute, and affecting user experience of the user. In this embodiment of the present disclosure, when detecting an operation of touching the touchscreen by a thumb of the user, the mobile terminal may collect statistics on duration for which the thumb of the user touches the touchscreen. When the duration for which the thumb of the user touches the touchscreen exceeds first preset duration (it is assumed that the first preset duration is one second), the mobile terminal may execute a response to the touch operation. If the touch operation does not end, that is, the thumb of the user still touches the touchscreen, the mobile terminal may continue to collect statistics on the duration of the touch operation. When the duration of the touch operation is greater than second preset duration (it is assumed that the second preset duration is three seconds), the mobile terminal determines that the touch operation is an invalid operation. The mobile terminal returns to a state that exists when the response to the operation is not executed, thereby effectively reducing misoperations caused by accidental touch of a finger on the touchscreen when the user holds the mobile terminal.

Optionally, in this embodiment of the present disclosure, if a mobile terminal detects an operation on a touchscreen, and duration of the operation exceeds first preset duration, the mobile terminal outputs a short-cut menu corresponding to the operation to the touchscreen. When the duration of the operation exceeds second preset duration, the mobile terminal may hide the short-cut menu.

In this embodiment of the present disclosure, in the method for processing an operation shown in FIG. 1A, whether an operation on a touchscreen is a valid operation may be identified according to duration of the operation, thereby effectively identifying an operation on the touchscreen and lowering a probability of occurrence of a misoperation.

Optionally, in this embodiment of the present disclosure, in the process of the method shown in FIG. 1A, before the operation on the touchscreen ends, if another operation that is performed on the touchscreen and whose type is the same as a type of the operation is detected, whether the other operation is a valid operation or an invalid operation may be identified according to duration of the other operation.

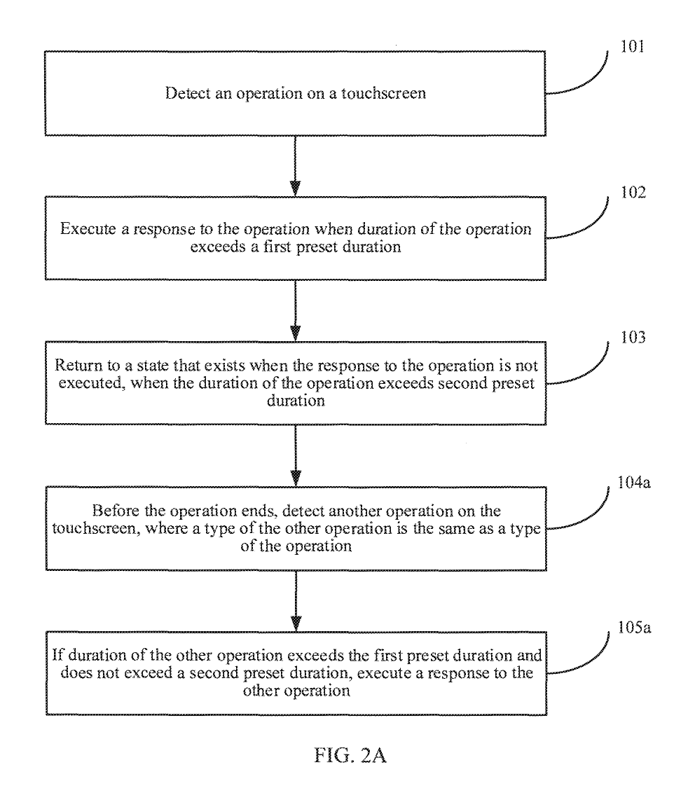

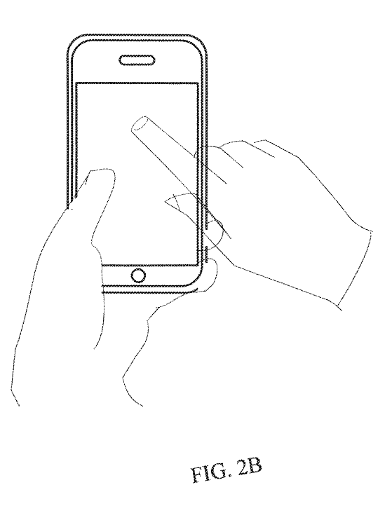

Correspondingly, referring to FIG. 2A, FIG. 2A is a schematic flowchart of another method for processing an operation according to an embodiment of the present disclosure. Compared with the process of the method shown in FIG. 1A, in addition to step 101 to step 103, the process of the method shown in FIG. 2A may further include the following steps.

It should be noted that, step 104a and step 105a are performed by a mobile terminal or a processor in a mobile terminal, for example, a CPU.

Step 104a: Before the operation ends, detect another operation on the touchscreen, where a type of the other operation is the same as a type of the operation.

Step 105a: If duration of the other operation exceeds the first preset duration and does not exceed the second preset duration, execute a response to the other operation.

In this embodiment of the present disclosure, after the mobile terminal determines that the duration of the operation (a first operation) on the touchscreen exceeds the second preset duration, before the first operation ends (for example, the first operation is performed when a thumb of the user touches the touchscreen while the user holds the mobile terminal, and the first operation ends when the thumb of the user leaves the touchscreen), the mobile terminal may further detect another operation on the touchscreen, for example, tap (for example, single tap and double tap), slide, or touch & hold.

In this embodiment of the present disclosure, after the mobile terminal detects the other operation (a second operation) on the touchscreen, if a type of the second operation is the same as a type of the first operation, for example, assuming that the first operation is touch & hold, and the second operation is also touch & hold, the mobile terminal may collect statistics on duration of the second operation. If the duration of the second operation exceeds the first preset duration, and does not exceed the second preset duration, the mobile terminal may execute a response to the second operation.

For example, referring to FIG. 2B, the first operation is performed when a thumb of the user touches the touchscreen while the user holds the mobile terminal with one hand, that is, the first operation is touch & hold. After the mobile terminal determines that duration for which the thumb of the user touches the touchscreen is greater than the second preset duration (it is assumed that the first preset duration is one second, and the second preset duration is three seconds), if the mobile terminal detects another operation (a second operation) on the touchscreen before the thumb of the user leaves the touchscreen and the second operation is also touch & hold, where it is assumed that duration of the second operation is two seconds, that is, the duration of the second operation exceeds the first preset duration and does not exceed the second preset duration, the mobile terminal may consider that the second operation is a valid operation, and perform a response to the second operation, thereby ensuring that the mobile terminal can normally respond to, in a case in which a finger accidentally touches the touchscreen when the user holds the mobile terminal, another touch operation input by the user.

In this embodiment of the present disclosure, if the duration of the second operation also exceeds the second preset duration, the mobile terminal may also consider that the second operation is also an invalid operation. Further, the mobile terminal may return to a state that exists when the response to the second operation is not executed. For a specific processing process thereof, refer to a processing process of the mobile terminal when the duration of the first operation exceeds the second preset duration in the process of the method shown in FIG. 1A, and details are not described herein again.

In the method for processing an operation shown in FIG. 2A, if a second operation that is performed on the touchscreen and whose type is the same as a type of the first operation is detected before the first operation ends, and the second operation is a valid operation, the second operation may be normally responded to.

Optionally, in this embodiment of the present disclosure, in the process of the method shown in FIG. 1A, before the operation on the touchscreen ends, if another operation that is performed on the touchscreen and whose type is different from a type of the operation is detected, a response to the other operation may be performed.

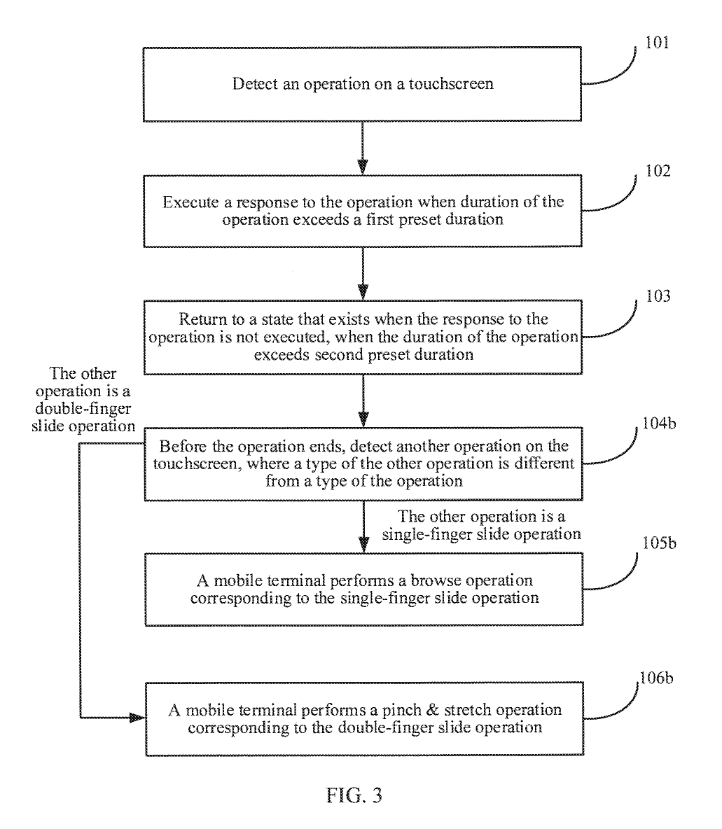

Correspondingly, referring to FIG. 3, FIG. 3 is a schematic flowchart of another method for processing an operation according to an embodiment of the present disclosure. Compared with the process of the method shown in FIG. 1A, in addition to step 101 to step 103, the process of the method shown in FIG. 3 may further include the following steps.

It should be noted that, step 104b to step 106b are performed by a mobile terminal or a processor in a mobile terminal, for example, a CPU. Besides, in the process of the method shown in FIG. 3, it is preset in the mobile terminal that double-finger slide is a pinch & stretch operation, and single-finger slide is a browse operation, where the double-finger slide refers to that two fingers simultaneously slide on the touchscreen.

Step 104b: Before the operation ends, detect another operation on the touchscreen, where a type of the other operation is different from a type of the operation.

Step 105b: If the other operation is a single-finger slide operation, A mobile terminal performs a browse operation corresponding to the single-finger slide operation.

Step 106b: If the other operation is a double-finger slide operation, A mobile terminal performs a pinch & stretch operation corresponding to the double-finger slide operation.

In this embodiment of the present disclosure, before the operation (a first operation) on the touchscreen ends (for example, the first operation is performed when a thumb of a user touches the touchscreen while the user holds the mobile terminal, and the first operation ends when the thumb of the user leaves the touchscreen), the mobile terminal may further detect another operation on the touchscreen, for example, tap (for example, single tap and double tap), slide, or touch & hold.

In this embodiment of the present disclosure, after the mobile terminal detects another operation (a second operation) on the touchscreen, the mobile terminal may execute a response to the second operation if a type of the second operation is different from a type of the first operation, for example, if the first operation is touch & hold, and the second operation is slide.

If the second operation is single-finger slide, the mobile terminal may execute the response to the second operation according to a direction in which a finger slides on the touchscreen.

For example, the user browses a webpage using the mobile terminal. When a single finger of the user slides upwards on the touchscreen, the mobile terminal may drag the webpage upwards, and when a single finger of the user slides upwards on the touchscreen, the mobile terminal may drag the webpage downwards.

For another example, the user browses, using the mobile terminal, a picture stored in the mobile terminal. When a single finger of the user slides to left on the touchscreen, the mobile terminal may display a next picture on the touchscreen, and when a single finger of the user slides to right on the touchscreen, the mobile terminal may display a previous picture on the touchscreen.

If the second operation is double-finger slide, the mobile terminal may execute the response to the second operation according to whether double fingers of the user slide towards each other or slide away from each other on the touchscreen.

For example, the user browses, using the mobile terminal, a picture stored in the mobile terminal. When double fingers of the user slide towards each other on the touchscreen (that is, the double fingers get close to each other), the mobile terminal may pinch a picture currently displayed on the touchscreen, and when double fingers of the user slide away from each other on the touchscreen (that is, the double fingers get away from each other), the mobile terminal may stretch a picture currently displayed on the touchscreen.

In the method for processing an operation shown in FIG. 3, if a second operation that is performed on the touchscreen and whose type is different from a type of the first operation is detected before the first operation ends, the second operation may be normally responded to.

In this embodiment of the present disclosure, when a mobile terminal detects an operation on a touchscreen, the mobile terminal determines, by referring to the processes of the methods shown in FIG. 1A to FIG. 3 and according to duration of the operation, whether the operation is a valid operation or an invalid operation. Alternatively, the mobile terminal may determine, according to a touch area of the operation, whether the operation is a valid operation or an invalid operation.

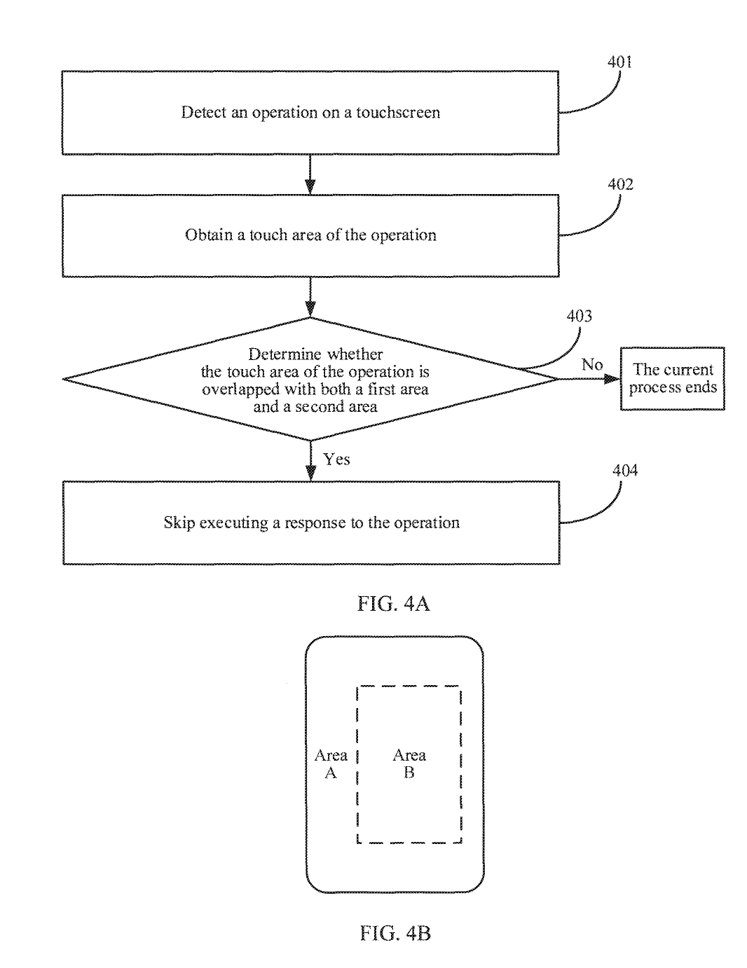

The following describes the technical solution of determining, according to a touch area of the operation, whether the operation is a valid operation provided in this embodiment of the present disclosure in detail with reference to FIG. 4A to FIG. 6.

Referring to FIG. 4A, FIG. 4A is a schematic flowchart of a method for processing an operation according to an embodiment of the present disclosure. In the method for processing an operation shown in FIG. 4A, a touchscreen may include a first area and a second area. The first area surrounds the second area.

As shown in FIG. 4A, the method for processing an operation may include the following steps.

It should be noted that, step 401 to step 404 are performed by a mobile terminal or a processor in a mobile terminal, for example, a CPU.

Step 401: Detect an operation on a touchscreen.

Step 402: Obtain a touch area of the operation.

In this embodiment of the present disclosure, when the mobile terminal detects the operation on the touchscreen, the mobile terminal may obtain the touch area of the operation. For example, the user touches the touchscreen using a finger. The touch area of the operation is an area touched by the finger of the user on the touchscreen.

Step 403: Determine whether the touch area of the operation is overlapped with both the first area and the second area. If the touch area of the operation is overlapped with both the first area and the second area, perform step 404, and otherwise, the current process ends.

In this embodiment of the present disclosure, after obtaining the touch area of the operation on the touchscreen, the mobile terminal may determine whether the touch area of the operation is overlapped with both the first area and the second area, that is, determines whether the touch area of the operation not only includes a part of the first area but also includes a part of the second area. For example, the user touches the touchscreen using a finger, the mobile terminal determines whether the finger of the user simultaneously touches the first area and the second area.

In this embodiment of the present disclosure, when the mobile terminal determines that the touch area of the operation is overlapped with both the first area and the second area, that is, the touch area of the operation not only includes a part of the first area but also includes a part of the second area, the mobile terminal may consider that the operation is an invalid operation, that is, the mobile terminal may skip executing a response to the operation.

A touchscreen shown in FIG. 4B is used as an example. In the touchscreen shown in FIG. 4B, an area A (a part surrounded by both a solid-line box and a dashed-line box) is an edge (a non-touch area) of a touchscreen of an existing mobile terminal, and an area B (a part surrounded by the dashed-line box) is a touch area of the touchscreen of the mobile terminal. In this embodiment of the present disclosure, a touch area of the touchscreen of the mobile terminal is extended from the area B to the area A, that is, the touchscreen in this embodiment of the present disclosure include the area A and the area B, where the area A is the first area, and the area B is the second area. When the mobile terminal detects a touch operation of touching the touchscreen by the finger of the user, the mobile terminal may determines whether a touch area of the touch operation is overlapped with both the area A and the area B, that is, whether the finger of the user simultaneously touches the area A and the area B. If the finger of the user simultaneously touches both the area A and the area B, the mobile terminal may skip executing a response to the touch operation.

In this embodiment of the present disclosure, when the mobile terminal determines that the touch area of the operation on the touchscreen is not overlapped with the first area, or the touch area of the operation is not overlapped with the second area, the mobile terminal may determine that the operation is a valid operation and execute a response to the operation. Alternatively, the mobile terminal may determine, using another strategy, whether to execute a response to the operation. For example, whether to execute a response to the operation is determined with reference to the processes of the methods shown in FIG. 1A to FIG. 3. Specific implementation thereof is not limited in this embodiment of the present disclosure.

Step 404: Skip executing a response to the operation.

In this embodiment of the present disclosure, when the mobile terminal detects the operation on the touchscreen and determines that the touch area of the operation is overlapped with both the first area and the second area, the mobile terminal may skip executing the response to the operation, for example, skip the response to the operation, or ignore the response to the operation.

For example, referring to FIG. 4B, for a mobile terminal having a relatively large screen (for example, a mobile phone having a touchscreen), when operating the mobile terminal, a user generally needs to hold the mobile terminal with one hand, and perform an operation (for example, tap, slide, and touch & hold) on the mobile terminal with the other hand. When the user holds the mobile terminal with one hand in order to better balance the mobile terminal, a finger of the user easily touches the touchscreen, thereby triggering the mobile terminal to execute a response that the user does not intend to execute, and affecting usage experience of the user. In this embodiment of the present disclosure, when detecting an operation of touching the touchscreen by a thumb of the user, the mobile terminal may obtain a touch area touched by the thumb of the user on the touchscreen. When the touch area is overlapped with both the area A and the area B, the mobile terminal identifies that the operation is an invalid operation, and skips executing a response to the operation, thereby effectively reducing misoperations caused by accidental touch of a finger on the touchscreen when the user holds the mobile terminal.

Optionally, in this embodiment of the present disclosure, when the mobile terminal detects the operation on the touchscreen, the mobile terminal may output a short-cut menu corresponding to the operation to the touchscreen, where the short-cut menu includes at least one operation option. Further, when the mobile terminal determines that the touch area of the operation is overlapped with both the first area and the second area, the mobile terminal may hide the short-cut menu corresponding to the operation.

For example, the operation is performed when a thumb of the user touches the touchscreen while the user holds the mobile terminal. Assuming that an operation that is preconfigured in the mobile phone and that responds to the operation is a select operation, and the user may further select an operation such as copy, cut, and delete for an selected object, in this embodiment of the present disclosure, when the mobile terminal detects the foregoing operation, a short-cut menu including operation options such as “copy,” “cut,” and “delete” may pop up on the touchscreen. When the mobile terminal determines that a touch area of the operation is overlapped with both a first area and a second area, the mobile terminal may hide the short-cut menu.

In this embodiment of the present disclosure, according to the method for processing an operation shown in FIG. 4A, a touchscreen is divided into a first area and a second area, and whether an operation is a valid operation is determined according to whether a touch area of the operation on the touchscreen is overlapped with both the first area and the second area, thereby effectively identifying an operation on the touchscreen and lowering a probability of occurrence of a misoperation.

Optionally, in this embodiment of the present disclosure, in the process of the method shown in FIG. 4A, if another operation on the touchscreen is detected before the operation on the touchscreen ends, whether the other operation is a valid operation or an invalid operation can be identified according to a touch area of the other operation.

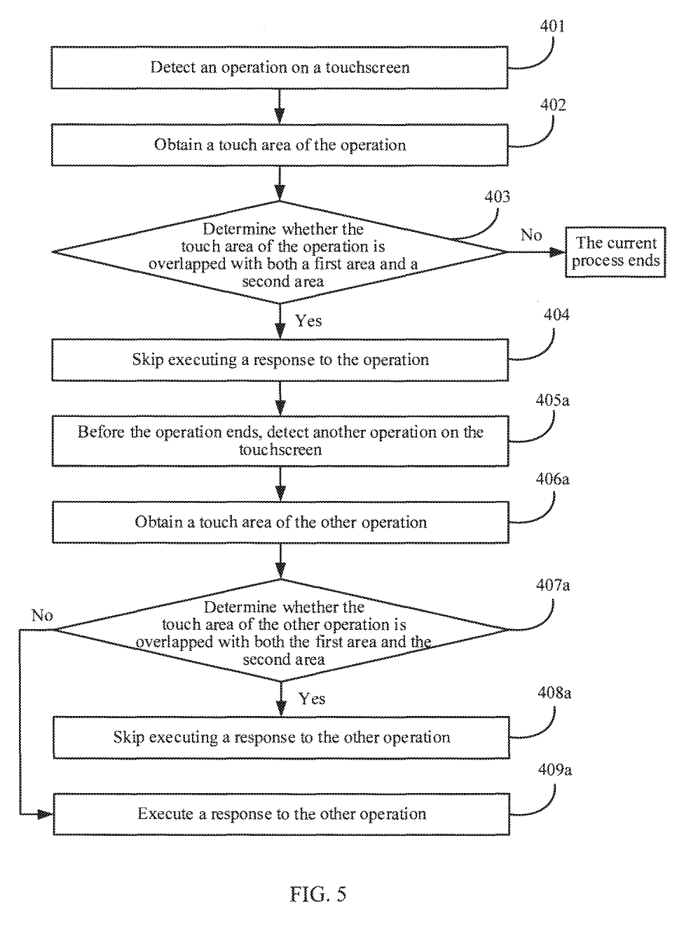

Correspondingly, referring to FIG. 5, FIG. 5 is a schematic flowchart of another method for processing an operation according to an embodiment of the present disclosure. Compared with the process of the method shown in FIG. 4A, in addition to step 401 to step 404, the process of the method shown in FIG. 5 may further the following steps.

It should be noted that, step 405a to step 409a are performed by a mobile terminal or a processor in a mobile terminal, for example, a CPU.

Step 405a: Before the operation ends, detect another operation on the touchscreen.

Step 406a: Obtain a touch area of the other operation.

Step 407a: Determine whether the touch area of the other operation is overlapped with both the first area and the second area, and if the touch area of the other operation is overlapped with both the first area and the second area, perform step 408a, and otherwise, perform step 409a.

In this embodiment of the present disclosure, before the operation (a first operation) on the touchscreen ends (for example, the first operation is performed when a thumb of a user touches the touchscreen while the user holds the mobile terminal, and the first operation ends when the thumb of the user leaves the touchscreen), the mobile terminal may further detect another operation on the touchscreen, for example, tap (for example, single tap and double tap), slide, or touch & hold.

In this embodiment of the present disclosure, after detecting the other operation (a second operation) on the touchscreen, the mobile terminal may further determine whether a touch area of the second operation is overlapped with both the first area and the second area. For specific implementation thereof, refer to related descriptions in step 403, and details are not described herein again.

Step 408a: Skip executing a response to the other operation.

In this embodiment of the present disclosure, when the mobile terminal determines that the touch area of the second operation is overlapped with both the first area and the second area, the mobile terminal may skip executing the response to the second operation, for example, skip the response to the second operation, or ignore the response to the second operation.

Step 409a: Execute a response to the other operation.

In this embodiment of the present disclosure, when the mobile terminal determines that the touch area of the second operation is not overlapped with the first area, or the touch area of the second operation is not overlapped with the second area, the mobile terminal may consider that the second operation is a valid operation, and execute a response to the second operation.

For example, the first operation is performed when a thumb of the user touches the touchscreen while the user holds the mobile terminal. After the mobile terminal determines that touching the touchscreen by the thumb of the user is an invalid operation, if the mobile terminal detects a second operation on the touchscreen before the thumb of the user leaves the touchscreen, for example, the user taps a button “setting,” where it is assumed that a touch area of the second operation is not overlapped with the first area, or a touch area of the second operation is not overlapped with the second area, the mobile terminal determines that the second operation is a valid operation and executes a response operation to the second operation, that is, enters a setting function interface, thereby ensuring that the mobile terminal can normally respond to, in a case in which a finger accidentally touches the touchscreen when the user holds the mobile terminal, another touch operation input by the user.

In this embodiment of the present disclosure, in the method for processing an operation shown in FIG. 5, if a second operation on the touchscreen is detected before the first operation ends, and the second operation is a valid operation, the second operation may be normally responded to.

Optionally, in this embodiment of the present disclosure, in the process of the method shown in FIG. 4A, it is assumed that double-finger slide on the touchscreen is preset to be a pinch & stretch operation, and single-finger slide is preset to be a browse operation, where the double-finger slide refers to that two fingers simultaneously slide on the touchscreen. If another operation on the touchscreen is detected before the operation on the touchscreen ends, whether the other operation is a valid operation or an invalid operation may be determined according to a touch area of the other operation. When the other operation is a valid operation, different responses may be further executed according to whether the other operation is double-finger slide or single-finger slide.

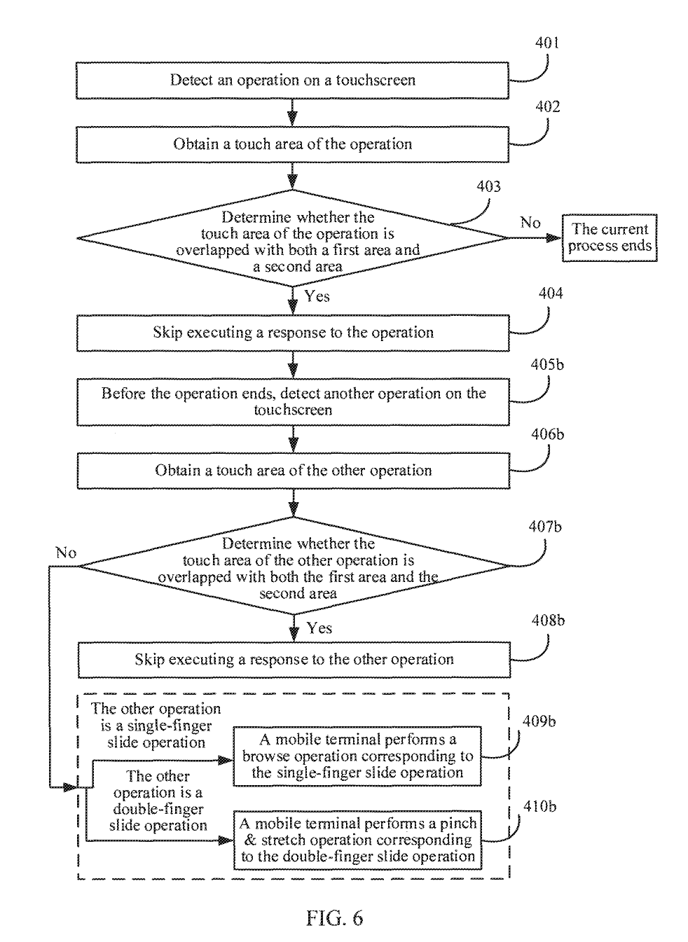

Correspondingly, referring to FIG. 6, FIG. 6 is a schematic flowchart of another method for processing an operation according to an embodiment of the present disclosure. Compared with the process of the method shown in FIG. 4A, in addition to step 401 to step 404, the process of the method shown in FIG. 6 may further include the following steps.

It should be noted that, step 405b to step 410b are performed by a mobile terminal or a processor in a mobile terminal, for example, a CPU.

Step 405b: Before the operation ends, detect another operation on the touchscreen.

Step 406b: Obtain a touch area of the other operation.

Step 407b: Determine whether the touch area of the other operation is overlapped with both the first area and the second area, and if the touch area of the other operation is overlapped with both the first area and the second area, perform step 408b, and otherwise, perform step 409b or 410b.

In this embodiment of the present disclosure, before the operation (a first operation) on the touchscreen ends (for example, the first operation is performed when a thumb of a user touches the touchscreen while the user holds the mobile terminal, and the first operation ends when the thumb of the user leaves the touchscreen), the mobile terminal may further detect another operation on the touchscreen, for example, tap (for example, single tap and double tap), slide, or touch & hold.

In this embodiment of the present disclosure, after detecting the other operation (a second operation) on the touchscreen, the mobile terminal may further determine whether a touch area of the second operation is overlapped with both the first area and the second area. For specific implementation thereof, refer to related descriptions in step 403, and details are not described herein again.

Step 408b: Skip executing a response to the other operation.

In this embodiment of the present disclosure, when the mobile terminal determines that the touch area of the second operation is overlapped with both the first area and the second area, the mobile terminal may skip executing the response to the second operation, for example, skip the response to the second operation, or ignore the response to the second operation.

Step 409b: When the other operation is a single-finger slide operation, the mobile terminal performs a browse operation corresponding to the single-finger slide operation.

Step 410b: When the other operation is a double-finger slide operation, the mobile terminal performs a pinch & stretch operation corresponding to the double-finger slide operation.

In this embodiment of the present disclosure, when the mobile terminal determines that the touch area of the second operation is not overlapped with the first area, or the mobile terminal determines that the touch area of the second operation is not overlapped with the second area, the mobile terminal may consider that the second operation is a valid operation, and execute the response to the second operation.

If the second operation is single-finger slide, the mobile terminal may execute the response to the second operation according to a direction in which a finger slides on the touchscreen.

For example, the user browses a webpage using the mobile terminal. When a single finger of the user slides upwards on the touchscreen, the mobile terminal may drag the webpage upwards, and when a single finger of the user slides upwards on the touchscreen, the mobile terminal may drag the webpage downwards.

For another example, the user browses, using the mobile terminal, a picture stored in the mobile terminal. When a single finger of the user slides to left on the touchscreen, the mobile terminal may display a next picture on the touchscreen, and when a single finger of the user slides to right on the touchscreen, the mobile terminal may display a previous picture on the touchscreen.

If the second operation is double-finger slide, the mobile terminal may execute the response to the second operation according to whether double fingers of the user slide towards each other or slide away from each other on the touchscreen.

For example, the user browses, using the mobile terminal, a picture stored in the mobile terminal. When double fingers of the user slide towards each other on the touchscreen (that is, the double fingers get close to each other), the mobile terminal may pinch a picture currently displayed on the touchscreen, and when double fingers of the user slide away from each other on the touchscreen (that is, the double fingers get away from each other), the mobile terminal may stretch a picture currently displayed on the touchscreen.

In this embodiment of the present disclosure, in the method for processing an operation shown in FIG. 6, if a second operation on the touchscreen is detected before the first operation ends, and the second operation is a valid operation, the second operation may be normally responded to.

Referring to FIG. 7, FIG. 7 is a schematic structural diagram of a mobile terminal according to an embodiment of the present disclosure. As shown in FIG. 7, the mobile terminal may include a detection module 701 configured to detect an operation on a touchscreen, and a processing module 702 configured to execute a response to the operation when duration of the operation exceeds first preset duration, and return to a state that exists when the response to the operation is not executed, when the duration of the operation exceeds second preset duration, where the second preset duration is greater than the first preset duration.

In this embodiment of the present disclosure, when the detection module 701 detects an operation on a touchscreen, the processing module 702 may be enabled. After being enabled by the detection module 701, the processing module 702 may collect statistics on duration of the operation. When the duration of the operation exceeds first preset duration, the processing module 702 may execute a response to the operation. In this case, if the operation still does not end, the processing module 702 may continue to collect statistics on the duration of the operation. If the duration of the operation exceeds second preset duration, the processing module 702 may consider that the operation is an invalid operation, and control the mobile terminal to return to a state that exists when the response to the operation is not executed.

In an optional embodiment, the processing module 702 may be further configured to output a short-cut menu corresponding to the operation to the touchscreen when the duration of the operation exceeds the first preset duration, where the short-cut menu includes at least one operation option, and hide the short-cut menu corresponding to the operation when the duration of the operation exceeds the second preset duration.

In this embodiment of the present disclosure, when the duration of the operation on the touchscreen exceeds the first preset duration, the processing module 702 may output the short-cut menu corresponding to the operation to the touchscreen. Further, if the duration of the operation does not exceed the second preset duration, that is, when the operation is a valid operation, the mobile terminal may perform a corresponding response operation according to a selection instruction of the user for an operation option in the short-cut menu. If the duration of the operation exceeds the second preset duration, the processing module 702 may consider that the operation is an invalid operation. Further, the processing module 702 may hide the short-cut menu corresponding to the operation.

In an optional embodiment, the detection module 701 is further configured to detect another operation on the touchscreen before the operation ends, where a type of the other operation is the same as a type of the operation, and correspondingly, the processing module 702 is further configured to execute a response to the other operation if duration of the other operation exceeds the first preset duration and does not exceed the second preset duration.

The processing module 702 may be further configured to return to a state that exists when the response to the other operation is not executed if the duration of the other operation exceeds the second preset duration.

In this embodiment of the present disclosure, after detecting the operation (the first operation) on the touchscreen, the detection module 701 may further detect another operation on the touchscreen.

If the processing module 702 determines that the first operation is an invalid operation, and the detection module 701 detects, before the first operation ends, another operation (the second operation) that is performed on the touchscreen and whose type is the same as the first operation, the detection module 701 may enable the processing module 702 to determine whether the second operation is a valid operation or an invalid operation. After the processing module 702 is enabled, if the processing module 702 determines that duration of the second operation exceeds the first preset duration, and does not exceed the second preset duration, the processing module 702 may determine that the second operation is a valid operation, and may further execute a response to the second operation. If the duration of the second operation exceeds the second preset duration, the processing module 702 may determine that the second operation is an invalid operation, and control the mobile terminal to return to a state that exists when the response to the other operation is not executed.

In an optional embodiment, the detection module 701 may be further configured to detect another operation on the touchscreen before the operation ends, where a type of the other operation is different from a type of the operation, and correspondingly, the processing module 702 may be further configured to execute a response to the other operation.

In this embodiment of the present disclosure, if the processing module 702 determines that the first operation is an invalid operation, and the detection module 701 detects, before the first operation ends, another operation that is performed on the touchscreen and whose type is different from a type of the first operation, the processing module 702 may be enabled to execute a response to the other operation.

For example, assuming that the first operation is a touch & hold operation, when the processing module 702 determines that the duration of the first operation exceeds the second preset duration, that is, when the first operation is an invalid operation, if the detection module 701 detects another operation on the touchscreen, where it is assumed that the other operation is a slide operation, the detection module 701 may directly enable the processing module 702 to execute a response to the other operation.

In this embodiment of the present disclosure, the mobile terminal shown in FIG. 7 may determine, according to duration of an operation on a touchscreen, whether the operation on the touchscreen is a valid operation or an invalid operation, thereby effectively identifying an operation on the touchscreen and lowering a probability of occurrence of a misoperation.

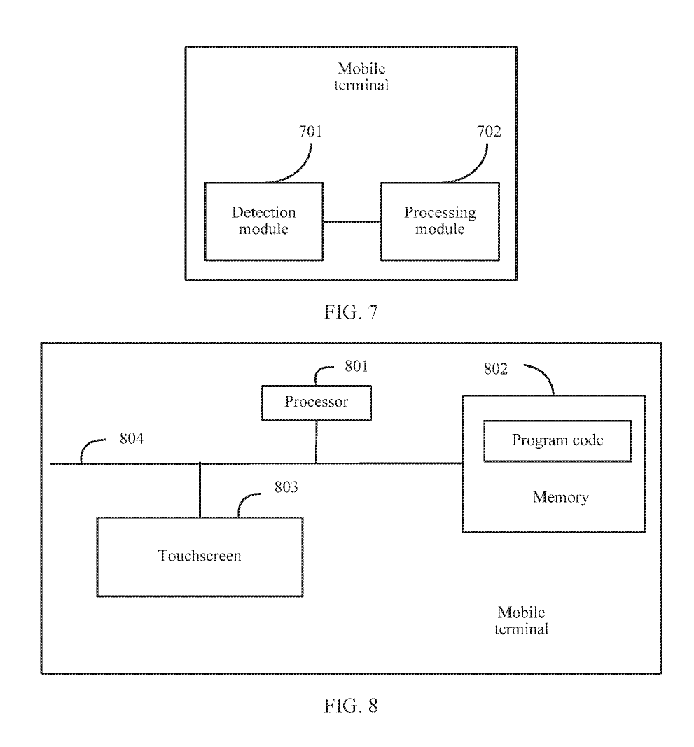

Referring to FIG. 8, FIG. 8 is a schematic structural diagram of another mobile terminal according to an embodiment of the present disclosure. The mobile terminal shown in FIG. 8 may include a bus 804, a processor 801 and a memory 802 that are connected to the bus 804, and a touchscreen 803, where the memory 802 stores program code, and the processor 801 is configured to invoke the program code stored in the memory 802 in order to perform the operations of detecting an operation on a touchscreen 803, executing a response to the operation when duration of the operation exceeds first preset duration, and returning to a state that exists when the response to the operation is not executed, when the duration of the operation exceeds second preset duration, where the second preset duration is greater than the first preset duration.

In an optional embodiment, executing, by the processor 801, a response to an operation includes outputting, by the processor 801, a short-cut menu corresponding to the operation to the touchscreen 803, where the short-cut menu includes at least one operation option, and returning, by the processor 801, to a state that exists when the response to the operation is not executed includes hiding, by the processor 801, the short-cut menu corresponding to the operation.

In an optional embodiment, the processor 801 may further perform the operations of detecting another operation on the touchscreen 803 before the operation ends, where a type of the other operation is the same as a type of the operation, and executing a response to the other operation if duration of the other operation exceeds the first preset duration and does not exceed the second preset duration.

In an optional embodiment, the processor 801 may further perform the operation of returning to a state that exists when the response to the other operation is not executed if the duration of the other operation exceeds the second preset duration.

In an optional embodiment, before the operation ends, the processor 801 may further perform the operation of detecting another operation on the touchscreen 803, and executing a response to the other operation, where a type of the other operation is different from a type of the operation.

It should be noted that, the mobile terminal shown in FIG. 8 merely shows components that are in a mobile terminal and that are required to perform the method for identifying a misoperation on a touchscreen provided in the embodiments of the present disclosure. Another component that the mobile terminal can be equipped with, such as a physical button, a keyboard, a power supply, or a housing is not shown in this embodiment of the present disclosure, because the other component does not affect implementation of this embodiment of the present disclosure.

In this embodiment of the present disclosure, the mobile terminal shown in FIG. 8 may determine, according to duration of an operation on a touchscreen 803, whether the operation is a valid operation or an invalid operation, thereby effectively identifying an operation on the touchscreen 803 and lowering a probability of occurrence of a misoperation. In addition, after the mobile terminal identifies that the operation on the touchscreen is an invalid operation, if the mobile terminal detects, before the operation ends, another operation that is performed on the touchscreen 803 and whose type is the same as a type of the operation and determines that the other operation is a valid operation, the mobile terminal may normally respond to the other operation. If the mobile terminal detects, before the operation ends, another operation that is performed on the touchscreen 803 and whose type is different from a type of the operation, the mobile terminal may normally respond to the other operation.

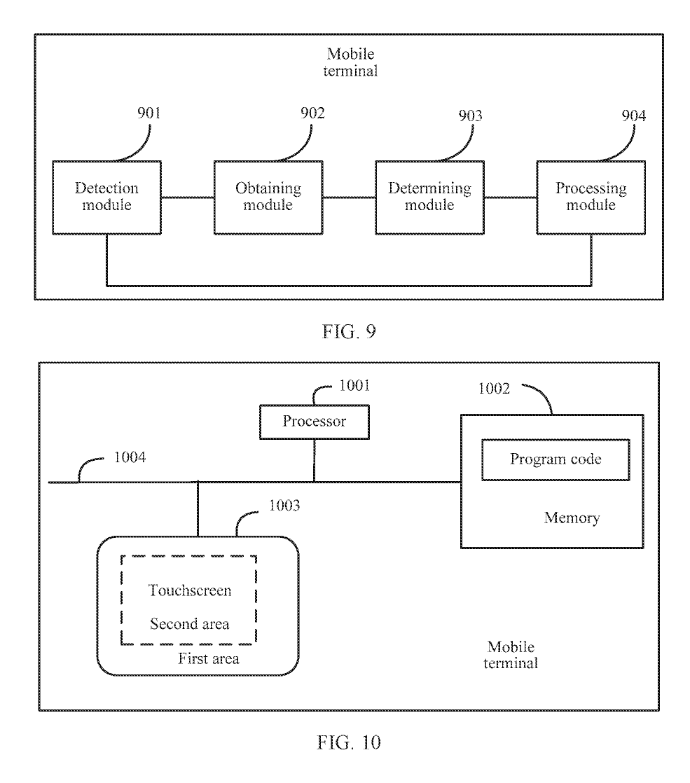

Referring to FIG. 9, FIG. 9 is a schematic structural diagram of a mobile terminal according to an embodiment of the present disclosure. In this embodiment, a touchscreen of the mobile terminal may include a first area and a second area, and the first area surrounds the second are. As shown in FIG. 9, the mobile terminal may include a detection module 901 configured to detect an operation on a touchscreen, where when the detection module 901 detects the operation on the touchscreen, an obtaining module 902 may be enabled. The obtaining module 902 configured to obtain a touch area of the operation, where the obtaining module 902 may output the obtained touch area of the operation to a determining module 903. The determining module 903 configured to determine whether the touch area of the operation is overlapped with both the first area and the second area, and a processing module 904 configured to skip executing a response to the operation when the determining module 903 determines that the touch area of the operation is overlapped with both the first area and the second area.

In this embodiment of the present disclosure, when the determining module 903 determines that the touch area of the operation is overlapped with both the first area and the second area, the processing module 904 may consider that the operation is an invalid operation and skip performing the response to the operation.

In an optional embodiment, when the determining module 903 determines that the touch area of the operation is overlapped with both the first area and the second area, the processing module 904 may further configured to skip the response to the operation, or ignore the response to the operation.

In an optional embodiment, the processing module 904 may be further configured to execute the response to the operation when the determining module 903 determines that the touch area of the operation is not overlapped with both the first area and the second area.

In this embodiment of the present disclosure, when the determining module 903 determines that the touch area of the operation is not overlapped with the first area, or the touch area is not overlapped with the second area, the processing module 904 may consider that the operation is a valid operation and execute the response to the operation. Alternatively, the mobile terminal may determine, using another strategy, whether the operation is an invalid operation or a valid operation. Specific implementation thereof is not described in detail herein.

In an optional embodiment, the detection module 901 may be further configured to detect another operation on the touchscreen before the first operation ends. The obtaining module 902 may be further configured to obtain a touch area of the other operation. The determining module 903 may be further configured to determine whether the touch area of the other operation is overlapped with both the first area and the second area, and the processing module 904 may be further configured to perform a response operation to the other operation when the determining module 903 determines that the touch area of the other operation is not overlapped with the first area, or the touch area of the other operation is not overlapped with the second area.

The processing module 904 may be further configured to skip executing the response to the other operation when the determining module 903 determines that the touch area of the other operation is overlapped with both the first area and the second area.

In this embodiment of the present disclosure, after detecting the operation (the first operation) on the touchscreen, the detection module 901 may also detect another operation on the touchscreen.

When the first operation is an invalid operation, and the detection module 901 detects, before the first operation ends, the other operation (a second operation) on the touchscreen, the obtaining module 902 may be enabled to obtain a touch area of the second operation. After the obtaining module 902 obtains the touch area of the second operation, the determining module 903 may be enabled to determine whether the touch area of the second operation is overlapped with both a first area and a second area. If the determining module 903 determines that the touch area of the second operation is not overlapped with both the first area and the second area, the processing module 904 may consider that the second operation is a valid operation, and further execute a response to the second operation. If the determining module 903 determines that the touch area of the second operation is overlapped with both the first area and the second area, the processing module 904 may consider that the second operation is an invalid operation and skip performing a response to the second operation.

In this embodiment of the present disclosure, the mobile terminal shown in FIG. 9 may determine, according to a touch area of an operation on a touchscreen, whether the operation is a valid operation or an invalid operation, and when the operation is an invalid operation, the mobile terminal skips executing a response to the operation, thereby effectively lowering a probability of occurrence of a misoperation. In addition, if the mobile terminal detects another operation on the touchscreen before the operation ends and determines that the other operation is a valid operation, the mobile terminal may normally respond to the other operation.

Referring to FIG. 10, FIG. 10 is a schematic structural diagram of another mobile terminal according to an embodiment of the present disclosure. The mobile terminal shown in FIG. 10 may include a bus 1004, a processor 1001 and a memory 1002 that are connected to the bus 1004, and a touchscreen 1003, where the touchscreen 1003 includes a first area and a second area, and the first area surrounds the second area, and the memory 1002 stores a program code, and the processor 1001 is configured to invoke the program code stored in the memory 1002 in order to perform the operations of detecting an operation on a touchscreen 1003, obtaining a touch area of the operation, determining whether the touch area of the operation is overlapped with both the first area and the second area, and skipping executing a response to the operation if the touch area of the operation is overlapped with both the first area and the second area.

In an optional embodiment, invoking, by the processor 1001, the program code stored in the memory 1002 in order to skip executing a response to the operation includes skipping, by the processor 1001, the response to the operation, or ignoring, by the processor 1001, the response to the operation.

In an optional embodiment, the processor 1001 may further perform the operation of executing the response to the operation if the touch area of the operation is not overlapped with both the first area and the second area.

In an optional embodiment, after the touch area of the operation is overlapped with both the first area and the second area, and before the operation ends, the processor 1001 may further perform the operations of detecting another operation on the touchscreen 1003, obtaining a touch area of the other operation, determining whether the touch area of the other operation is overlapped with both the first area and the second area, and executing a response to the other operation if the touch area of the other operation is not overlapped with the first area, or the touch area of the other operation is not overlapped with the second area.

In an optional embodiment, the processor 1001 may further perform the operation of skipping executing the response to the other operation if the touch area of the other operation is overlapped with both the first area and the second area.

It should be noted that, the mobile terminal shown in FIG. 10 merely shows components that are in a mobile terminal and that are required to perform the method for identifying a misoperation on a touchscreen 1003 provided in the embodiments of the present disclosure. Another component that the mobile terminal can be equipped with, such as a physical button, a keyboard, a power supply, or a housing is not shown in this embodiment of the present disclosure, because the other component does not affect implementation of this embodiment of the present disclosure.

In this embodiment of the present disclosure, the mobile terminal shown in FIG. 10 may determine, according to a touch area of an operation on a touchscreen 1003, whether the operation is a valid operation or an invalid operation, and when determining that the operation is an invalid operation, the mobile terminal skips executing a response to the operation, thereby effectively identifying an operation on the touchscreen 1003 and lowering a probability of occurrence of a misoperation. In addition, if the mobile terminal detects another operation on the touchscreen 1003 before the operation ends, and determines that the other operation is a valid operation, the mobile terminal may normally respond to the other operation.

In the foregoing embodiments, the description of each embodiment has respective focuses. For a part that is not described in detail in an embodiment, reference may be made to related descriptions in other embodiments.

A person of ordinary skill in the art may understand that all or some of the steps of the method embodiments may be implemented by a program instructing related hardware of a terminal device. The program may be stored in a computer-readable storage medium. When the program is performed, the steps including the foregoing method embodiments are performed. The foregoing storage medium includes any medium that can store program code, such as a flash memory, a read-only memory (ROM), a random access memory (RAM), a magnetic disk, or an optical disc.

The above describes a method used by a touchscreen to process an operation and a terminal according to the embodiments of the present disclosure in detail. In this specification, specific examples are used to describe the principle and implementation manners of the present disclosure, and the description of the embodiments is only intended to help understand the method and core idea of the present disclosure. Meanwhile, a person of ordinary skill in the art may, based on the idea of the present disclosure, make modifications with respect to the specific implementation manners and the application scope. Therefore, the content of this specification shall not be construed as a limitation to the present disclosure.

1.-30. (canceled)

31. A method for processing an operation, comprising:
detecting a first operation on a touchscreen;
executing a response to the first operation when a duration of the first operation exceeds a first preset duration;
returning to a state that exists when the response to the first operation is not executed when the duration of the first operation exceeds a second preset duration, wherein the second preset duration is greater than the first preset duration;
detecting a second operation on the touchscreen before the first operation ends, wherein a type of the second operation is the same as a type of the first operation; and
executing a response to the second operation when a duration of the second operation exceeds the first preset duration and does not exceed the second preset duration.

32. The method according to claim 31, wherein executing the response to the first operation comprises outputting a short-cut menu corresponding to the first operation to the touchscreen when the duration of the first operation exceeds the first preset duration, wherein the short-cut menu comprises at least one operation option, and wherein returning to the state that exists when the response to the first operation is not executed when the duration of the first operation exceeds the second preset duration comprises hiding the short-cut menu corresponding to the first operation when the duration of the first operation exceeds the second preset duration.

33. The method according to claim 31, wherein when the duration of the second operation exceeds the second preset duration, the method further comprises returning to a state that exists when the response to the second operation is not executed.

34. The method according to claim 31, wherein before the first operation ends, the method further comprises:
detecting a third operation on the touchscreen; and
executing a response to the third operation, wherein a type of the third operation is different from a type of the first operation.

35. A mobile terminal, comprising:
a memory comprising a program code;
a touchscreen; and
a processor, wherein the memory, the touchscreen and the processor are connected to each other using a bus, and wherein the program code cause the processor to be configured to:
detect a first operation on the touchscreen;
execute a response to the first operation when a duration of the first operation exceeds a first preset duration;
return to a state that exists when the response to the first operation is not executed when the duration of the first operation exceeds a second preset duration, wherein the second preset duration is greater than the first preset duration;
detect a second operation on the touchscreen before the first operation ends, wherein a type of the second operation is the same as a type of the first operation; and
execute a response to the second operation when a duration of the second operation exceeds the first preset duration and does not exceed the second preset duration.

36. The mobile terminal according to claim 35, wherein when executing the response to the first operation, the program code further causes the processor to be configured to output a short-cut menu corresponding to the first operation to the touchscreen, wherein the short-cut menu comprises at least one operation option, and wherein when returning to the state that exists when the response to the first operation is not executed, the program code further causes the processor to be configured to hide the short-cut menu corresponding to the first operation.

37. The mobile terminal according to claim 35, wherein when the duration of the second operation exceeds the second preset duration, the program code further causes the processor to be configured to return to a state that exists when the response to the second operation is not executed.

38. The mobile terminal according to claim 35, wherein before the first operation ends, the program code further causes the processor to be configured to:
detect a third operation on the touchscreen; and
execute a response to the third operation, wherein a type of the third operation is different from a type of the first operation.

39. A non-transitory computer readable medium comprising computer readable instructions that, when executed by a computer processor, cause the computer processor to implement the following operations;
detecting a first operation on a touchscreen;
executing a response to the first operation when a duration of the first operation exceeds a first preset duration;
returning to a state that exists when the response to the first operation is not executed when the duration of the first operation exceeds a second preset duration, wherein the second preset duration is greater than the first preset duration;
detecting a second operation on the touchscreen before the first operation ends, wherein a type of the second operation is the same as a type of the first operation; and
executing a response to the second operation when a duration of the second operation exceeds the first preset duration and does not exceed the second preset duration.

40. The non-transitory computer readable medium according to claim 39, wherein when executing the response to the first operation, the computer readable instructions further cause the computer processor to implement the operation of outputting a short-cut menu corresponding to the first operation to the touchscreen, wherein the short-cut menu comprises at least one operation option, and wherein when returning to the state that exists when the response to the first operation is not executed, the computer readable instructions further cause the computer processor to implement the operation of hiding the short-cut menu corresponding to the first operation.

41. The non-transitory computer readable medium according to claim 39, wherein when the duration of the second operation exceeds the second preset duration, the computer readable instructions further cause the computer processor to implement the operation of returning to a state that exists when the response to the second operation is not executed.

42. The non-transitory computer readable medium according to claim 39, wherein before the first operation ends, the computer readable instructions further cause the computer processor to implement the following operations:
detecting a third operation on the touchscreen; and
executing a response to the third operation, wherein a type of the third operation is different from a type of the first operation.
